(19) United States
(12) Patent Application Publication
(10) Pub. No.: US 2013/0306855 A1
(43) Pub. Date: Nov. 21, 2013

(54) EFFICIENT DETECTION OF ION SPECIES UTILIZING FLUORESCENCE AND OPTICS

(71) Applicant: Fasmatech Science & Technology SA, Athens (GR)

(72) Inventors: EMMANUEL RAPTAKIS, ATHENS (GR); Dimitris Papanastasiou, ATHENS (GR)

(73) Assignee: Fasmatech Science & Technology SA, Athens (GR)

(21) Appl. No.: 13/897,378

(22) Filed: May 18, 2013

(30) Foreign Application Priority Data
May 18, 2012 (GB) 1208843.1

(51) Int. Cl. H01J 49/40; H01J 49/00

(52) U.S. Cl. CPC H01J 49/40; H01J 49/0031
USPC 250/282; 250/287

(57) ABSTRACT

The present disclosure relates to mass spectrometers and ion mobility spectrometers and methods for utilizing them and, in particular, to efficient detection of large size ionic species by attaching fluorescent agents to such species and utilizing high intensity light and appropriate optics to define a detection plane. A mechanism to detect fluorescence photons with high efficiency is coupled thereto. In an exemplary embodiment, a mass or ion mobility analyzer is utilized to separate fluorescent ionic species in space or time. The ionic species absorb and re-emit photons as they transverse the detection plane. The photons are directed to a photon detector that generates an electric signal that defines time or position (or position and time of intersection) of ionic species with the detection plane.

### CROSS REFERENCE TO RELATED APPLICATIONS

This application claims the benefit of U.K. Provisional Application No. 1208843.1, entitled, IMPROVEMENTS IN AND RELATING TO MASS AND SIZE MEASUREMENT OF IONS, filed on May 18, 2012, commonly owned and assigned to the same assignee hereof.

This application is also related to currently co-pending application U.S. patent application Ser. No. ______(Docket NO. FASMA001-US1), filed even date herewith, entitled, ION GUIDE WITH DIFFERENT ORDER MULTIPOLAR FIELD ORDER DISTRIBUTION ACROSS LIKE SEGMENTS, which claims priority to U.K. Provisional Application No. 1208849.8, entitled, APPARATUS AND METHOD FOR CONTROLLING IONS, filed on May 18, 2012, both applications of which are also commonly owned and assigned to the same assignee hereof.

### FIELD

The present disclosure relates techniques to mass spectrometer and ion mobility type equipment and components, and in particular, to ion detectors used therein capable of detecting particles with high mass and size.

### BACKGROUND

Mass spectrometry (MS) and ion mobility spectrometry are analytical tools used for quantitative elemental analysis of samples to measure the mass and size of ionised particles.

In an effort to identify the nature of certain molecules in a given sample, a spectrometer may be used. Spectrometers cause sourced molecules or molecular clusters present in a sample to become ionized. The ionized molecules can consequently be treated by a mass analyzer device which causes unlike ionized analyte particles (or simply, ion analytes) to separate in space and/or time due to their relative difference in mass or size. In turn, a separate detector device in the mass spectrometer is able to draw a mass and/or ion mobility spectrum based on this result.

A mass spectrum is useful to derive information about the masses and in some cases the quantities of the various analyte particles that make up the sample.

Similarly, an ion mobility spectrum provides information about the collisional cross-section of analyte species. From this cross-section, one can infer a geometrical size, confirmation and/or state of the various analyte particles. Some mass and mobility spectrometers perform both forms of detection from which to draw inferences about the molecules, proteins, or particles generally under analysis.

There are a number of known ionization systems for analyzing analyte ions in mass spectrometry as well as ion mobility spectrometry. Known methodologies of such systems include Atmospheric Pressure Matrix Assisted Laser Desorption Ionization (AP-MALDI), Atmospheric Pressure Photoionization (APPI), Electrospray Ionization (ESI), Atmospheric Pressure Chemical Ionization (APCI), Inductively Coupled Plasma (ICP), radioactive ion sources, Laser Ablation (LA), and high vacuum Matrix Assisted Laser Desorption and Ionization (MALDI). Using these methodologies, it's been possible to desorb and ionize very large molecular species or clusters which are characterized by particles whose individual masses exceed 1,000,000 Da.

Once generated, analyte ions are separated in time and/or space based on the properties of the chosen analytical technology. Typically, the analyzer section of a mass spectrometer is maintained at high vacuum levels from 10⁻⁴ Torr to 10⁻⁸ Torr.

In an ion mobility analyzer, pressure is higher (e.g., 10³ Torr to 10⁻² Torr) which can cause analyte ions to multiply collide with surrounding gas molecules (buffer gas). In this case analyte ions are found within an accelerating electrical field. The interaction of the electrical field and the multiple collisions cause the analyte ions to acquire a terminal velocity. Terminal velocity is primarily dependent on electrical field strength, charge state, cross-section (size) of analyte ions, buffer gas pressure and buffer gas type. Ultimately, non-like ion analytes separate in time and space. Analyte ions are then directed to a detection stage where relative position as a function of time and space is established from which it is possible to infer respective cross-section.

Ion detection is a critical aspect of mass spectrometric and ion mobility apparata.

Ion detectors are categorized in several ways. One such way is in terms of the process methodology employed (e.g., multiple stage electron multiplier, multichannel plates, faraday caps, cryogenic detectors, and the like). Another way is on the basis of the target ions being analyzed or detected (e.g., small ions, high energy ions, large ions, etc.). Another way is on the basis of the pressure range in which the detector is said to operate or what happens to the measured ion beam (destructive versus non-destructive detectors).

Early ion detectors made determinations based on detection of an ion by recording its physical trace on special surfaces such as photographic plates. Faraday cups were later introduced that detected charges deposited on a conductive surface as a way to infer the presence of specific ions. Such early techniques were not providing high current signals even for cases of small, highly energetic ions, which characteristically are easier to inferentially detect, thus limiting sensitivity of the respective spectrometers.

Modem detectors used in today's mass spectrometry utilize a conversion dynode (as a separate component or as part of a front-end of the detector) which converts incident ions into electrons. In a next stage of processing, multistage amplification of the electrons is performed to amplify single-ion events to a measurable current level. It is possible with the use of discrete dynode electron multipliers, and/or multichannel plates or single channel multipliers to achieve considerable amplification (as high as >10³-10⁶).

Hybrid-type detection systems include a scintillator stage coupled after the first stage amplification described above to transform ion-converted electrons into photons. A photomultiplier is then used to detect the photons. One such hybrid system is known as the Daly detector and is primarily used to post-accelerate ions onto an off-axis pad and to then accelerate secondary electrons onto a scintillator opposite the pad.

Some Daly-type detector systems electrically decouple ion-to-electrons conversion from photon detection altogether. In this way, while ion detection may occur at a very high floating voltage, the voltage potential of a photomultiplier anode is maintained at near zero ground potential.

Cryogenic detectors, another type of detector system, detect particle arrivals resulting from the solid state excitation energy deposited on an ultra-cold surface by impinging ions. In this regard, cryogenic detectors are energy detectors capable of detecting ions (and neutrals) without the need to generate secondary electrons.

More recent approaches are those employed by photodiode-like devices which perform direct detection of ion arrivals on room temperature semiconductor surfaces. The basic principle is to detect the presence of electron-hole pair formed at the impact of an energetic ion. One drawback of such devices is that they are limited to relatively high energy ion detection (>1 keV/amu) type applications.

Image current detectors provide yet another detection methodology. Such devices detect the presence of ions based on the fact that ion packets—flying in close proximity to a conductor—generate an image current in the conductor. This image current is capable of being subsequently amplified by appropriate electronics. Acquired signals can be processed further and reveal the mass or mobility of analyte ions.

Image current detectors are uniquely non-destructive in that an ion beam may be measured and detected without splatting ions on any surface, as with many conventional systems.

Unfortunately, image currents generated by image current detectors are very low often requiring repeated measurements until an acceptable signal-to-noise ratio is achieved. For this reason, image current detectors are typically used in applications involving ions capable of being trapped within a periodic motion trajectory, e.g., a Fourier Transform Ion Cyclotron Radiation mass spectrometer or an Orbitrap mass spectrometer.

With the exception of image current detectors, conventional systems require the analyte ions, as previously explained, to strike/impact against an ion-destroying surface which ultimately renders the ions themselves unavailable for further measurements.

Non-destructive detectors, such as image current detectors, when employed as part of a mass analyzer capable of engaging ions in periodic motion, have the advantage of measuring the same ions many times over which inherently does improve the signal-to-noise ratio challenge. Unfortunately, for non-periodic type ion detection and measurement, particularly where high sensitivity is very important to the analysis, current non-destructive detector systems are not deployable.

Image current detectors also tend to require a minimum amount of fundamental charge (i.e, the charge of a single electron or a single proton) to register a signal. This minimum amount of fundamental charge is typically around 10 to 30 charges in total. Conventional image current detectors are unable to detect charge ions below the minimum amount of fundamental charge, such as that of single or low charge ions.

Practical applications of many mass spectrometer detectors that utilize collisions of the incoming analyte ions to generate and multiply secondary electrons (using for example secondary electron multipliers and channel plates) are those involving detection of low to moderate values of mass-to-charge (m/z) ratio (a few Th up to ˜10⁶ Th). The practical limitation stems from the fact that for adequate secondary electron generation efficiency very high velocity of impact is required. To detect high m/z (e.g., 20,000 Th to 1,000,000 Th) conventional mass spectrometers must accelerate ions to potentials in excess of 20,000V or 30,000V. Such high potential requirements increase design complexity and cost and are generally prone with decreased operating reliability.

For applications requiring analysis of high mass particles, where secondary electron multipliers or channel plates are employed, it is common to introduce a post-acceleration stage that increases the velocity of larger ions prior to impact on the detector medium. This approach however further increases design complexity and cost as well as introduces problems with peak broadening, which attributes to a loss of resolution of measurement.

Cryogenic detectors, while capable of detecting low velocity particles, they suffer from high cost, are typically very small (a few tens microns square per detector) and require a complex and expensive cryogenic stage and a steady supply of liquid nitrogen.

For much larger ionized particles, e.g. aerosol particles or even whole viruses, further known techniques are used to detect a charged species. Such techniques include the detection of light scattered by very large ions using a light source and a photon multiplier. In one solution, a very large ion (>10⁸ Da) is electrosprayed into a quadrupole ion trap and ejected using resonant ejection. The ejected ion intercepts a laser beam set adjacent to the ion trap exit. The large size particles scatter enough light to register a signal on a photomultiplier set at an appropriate observation point. With this approach it is theoretically possible to achieve single particle measurements; m/z can be determined by the ion ejection properties of the ion trap when the ions are detected.

Another related theoretical approach, which uses light scattering to determine ions passing through a point in space, employs a FAIMS differential mobility analyzer coupled with a light scattering detector to detect ions passing through a differential mobility filter. As a practical matter, light scattering efficiency for small particles is very low with such devices. When the target particles have a size of approximately 1-100 nm (typical size for a protein or protein complex) Raleigh scattering displays a very low probability for light scattering even for short non-ionizing light wavelengths (300-400 nm). In practical terms, it would require a very high number of particles to register a signal, which makes the light scattering approach impractical for modem, high sensitivity mass spectrometric and ion mobility instrumentation.

Another practical limitation of the aforementioned ion detectors is the requirement to operate at high vacuum (pressure <10⁻³ torr, preferably <10⁻⁶ torr). This limitation makes them incompatible with typical ion mobility spectrometer systems where higher pressures are typically required. To overcome this limitation, ion mobility spectroscopy systems employ faraday caps connected to very high electronic amplification stages; such system will limit the shortest measurable peak to several tens or hundreds microseconds. By contrast, state of the art electron multipliers measure peaks of several nanoseconds.

What is needed, therefore, are an apparatus and method, capable of detecting high mass ions with high efficiency which overcome the drawbacks described above.

### BRIEF DESCRIPTION OF THE DRAWINGS

FIG. 1 shows various protein molecules in a form of a helix to which are attached fluorophores capable of emitting fluorescent light when excited by radiation at specific wavelengths, in accordance with an exemplary embodiment.

FIG. 2 shows an ion detection system which uses a laser sheet disposed along a plane perpendicular to the direction of an ion conduit to provide ion separations as a function of time, in accordance with an exemplary embodiment.

FIG. 3 is a high level block diagram of an ion detection system in accordance with an exemplary embodiment.

FIG. 4 shows a fluorescence time-of-flight (TOF) detection system with two lasers operated at different wavelengths, in accordance with a further exemplary embodiment.

FIG. 5 shows a fluorescence TOF detection system with multiple detection planes in a yet a further exemplary embodiment.

FIG. 6 shows a coaxial multi-pass TOF mass analyzer employing two fluorescence detection systems for Fourier transform mass spectrometry experiments in another exemplary embodiment.

FIG. 7 shows a multi-turn TOF mass analyzer employing a plurality of fluorescence detection systems for Fourier transform mass spectrometry experiments in yet another exemplary embodiment.

FIG. 8 shows a hybrid mass spectrometer apparatus incorporating a low pressure ion mobility spectrometer and TOF mass analyzer in series, both equipped with fluorescence detection in yet another exemplary embodiment.

FIG. 9 is an operational flow diagram for attaching fluorescent agents to particles in order to emit photons as the particles pass through a detection area to help with identification of same in accordance with an exemplary embodiment.

### SUMMARY

The present disclosure relates to mass spectrometers and ion mobility spectrometers and methods for utilizing them and, in particular, to efficient detection of large size ionic species by attaching fluorescent agents to such species and utilizing high intensity light and appropriate optics to define a detection plane. A mechanism to detect fluorescence photons with high efficiency is coupled thereto.

In an exemplary embodiment, a mass or ion mobility analyzer is utilized to separate fluorescent ionic species in space or time. The ionic species absorb and re-emit photons as they transverse the detection plane. The photons are directed to a photon detector that generates an electric signal that defines time or position (or position and time of intersection) of ionic species with the detection plane.

In one aspect, ion species (e.g., large size ionic species) are efficiently detected by a methodology of attaching fluorescent agents to the species and utilizing light (e.g., high intensity light) and appropriate optics that define a spatially extended detection area or plane. This way, fluorescence photons emanating therefrom are detected with high efficiency.

In an exemplary embodiment, a mass or ion mobility analyzer is utilized to separate fluorescent ionic species in space or time. The ionic species are configured to absorb and re-emit photons as they transverse a detection area/plane. In one scenario, the photons are directed (using optics) to a photon detector which in turn generates an electrical signal that may be used to define a time and/or position (or position and time of intersection) of ionic species with the detection area/plane.

In another exemplary embodiment, drifting ions are generated that are separated in time and/or space on the basis of predefined ion characteristics (e.g., based on charge to mass ratio and/or collision cross section). This separation causes the drifting ions to drift through one or more light sheets. Light is detected from the drifting ions which light is generated from the interaction of the drifting ions with the light sheets. This way, time of detection may be determined or calculated relative to a predetermined start time of the drifting ion generation. The spatial separation between a reference location in the path of the drifting ions and the location of the light sheet may be predetermined. The mass or cross-section of ions may be determined using these parameters. The detected light may be scattered light which results from light within the light sheet scattering from an ion(s) whilst within the light sheet. The light may most preferably include emitted light from an ion(s) which results from fluorescence generated within the ion by absorption of light from the light sheet by an ion(s) whilst within the light sheet. The separation of drifting ions may be by use of a time-of-flight analyzer or methodology.

In one approach, ions are prepared with fluorescent markers, substances or components attached to them which are responsive to the light of the light sheet to fluoresce.

The sheet of light may also be arranged such that the direction of drift of the drifting ions is transverse to the plane of the sheet and most preferably substantially perpendicular. This approach can be non-destructive as to the detected ions making it possible to perform multiple detection events in implementations where multiple light sheets (and/or multiple passes through a given light sheet) are provided. The ability to perform multiple detections permits greater accuracy in final results by virtue of improving the detection statistics.

In addition, the present disclosure describes technique for the derivatization of ions, such as macromolecular ions, prior to mass analysis using mass spectrometry and ion mobility platforms or combinations of both. In one approach, the derivatization of ions, such as macromolecular ions, is performed with fluorescent chemical reagents. Such fluorophores are highly responsive to light and the absorption/emission of light radiation over narrow wavelength bands occurs with high efficiency. In another approach, derivatization of large biomolecules or macromolecular assemblies is accomplished by attaching fluorophores to specific sites. In applications with proteins as the target species for mass and/or ion mobility analysis, the fluorophores are attached to the proteins.

The derivatized molecular species may be ionized using “soft” ionization techniques, such as for example Matrix-Assisted Laser Desorption Ionization (MALDI) or Electrospray Ionization (ESI) or variations thereof, to prevent metastable decay or dissociation of non-covalent complexes. In a further aspect, scaffolding agents chemically modified to incorporate fluorophores are used.

In a further exemplary embodiment, ion separation involves accelerating ions to a terminal velocity and injecting them into a drift region where separation is accomplished either on the basis of differences in mass-to-charge (m/z) ratio or cross section. In one scenario, position and time of molecular species or other particles found in the gas phase is determined using light scattering or light fluorescence. This information is then used to determine mass or mobility of such molecular species or particles.

In an alternate exemplary embodiment, a device is provided that includes an ion source, a drift region where ions separate in time and/or space, and a detection mechanism that utilizes a light source and light detection where the light source defines the detection position and ion detection is carried out by observing light scattering or fluorescence.

In a further alternate exemplary embodiment, a method is provided to detect the position of an ion or ions. The approach involves providing a fluorescent to the ions or, alternatively, attaching a fluorescent agent to the ions which results in tagged ions. From there ions are directed into a path defined by an ion conduit. A detection area is created by providing a light sheet that extends across this path and which releases the (tagged) ions causing them to move therealong towards the detection area. As this happens, fluorescent light from the fluorescent (tagged) ions is detected as the (tagged) ions become excited by their interaction with the light sheet. This fluorescent light makes it possible to infer a position of the ions from the detected position of or within the light sheet.

In a further alternate exemplary embodiment, a method is provided that releases different fluorescent ions or tagged ions into an ion conduit. This causes physically different ions move therealong at different respective speeds according to their respective mass and/or size thereby to separate different ions within the drift tube accordingly. A fluorescent light from the different fluorescent ions or tagged ions is then detected at different times. Finally, physical differences between the different ions along such different times are determined.

In one aspect, there is further provided an apparatus that detects a position of an ion which includes (i) an ion conduit part for directing ions along a path; (ii) a detection part including a detection area in communication with the ion conduit and arranged to form a light sheet extending across the path for detecting fluorescent light from fluorescent ion(s) or ion(s) tagged with fluorescent agents excited by interaction with the light sheet, thereby to detect a position of the ion(s) as being a position of or within the light sheet; and (iii) an ion source part for releasing fluorescent ion(s) or tagged ion(s) into the ion conduit to move therealong towards the detection area.

The ion conduit part is preferably arranged to cause physically different ions to move therealong at different respective speeds according to their respective mass and/or size to thereby separate different ions within the drift tube accordingly. The detection part is also arranged to detect fluorescent light from the different fluorescent ions or tagged ions at different times attributable to physical differences between the different ions.

The detection part preferably includes optical means for collecting fluorescent light emitted in any one or more of a plurality of different direction from said ion(s) as they transverse the light sheet, and for directing the collected light to a photon detector.

The detection part may be arranged to form a plurality of separate said light sheets extending across a said path.

The detection part may include a plurality of separate detection areas each in communication with the ion conduit and each arranged to form a respective light sheet extending across a said path and each arranged to detect fluorescent light from fluorescent ion(s) or ion(s) tagged with fluorescent agents excited by interaction with the respective light sheet.

The apparatus may include a light source and a light-sheet optic for forming a said light sheet from light generated by the light source and the light source is a continuous wave laser or a light-emitting diode.

The detection part preferably includes a 2-dimensional photon detecting device arranged to record the position of detection of the fluorescent light within the light sheet. The 2-dimensional photon detecting device is arranged to record consecutive image frames at a frame rate higher than 100 frames per second.

The apparatus may further include a pulsed ionization source or an ion gate arranged to generate charged particle packets.

The ion conduit may be further arranged to separate said charged particle packets according to their velocities.

The ion conduit may also be arranged at high vacuum such that a flight of the charged particle packet through the ion conduit is substantially collision free, while the ion conduit itself is arranged to be substantially free of electrical field. Particles entering the drift tube possess substantially the same kinetic energy, such that a flight time through the ion conduit may be assigned to the mass of the particles.

The ion conduit may be arranged to provide quadrupolar field with characteristics such that ions of certain mass-to-charge ratio are dispersed and removed from the ion conduit while selected ions pass successfully through the conduit and arrive at the light sheet, generating photons and registering a signal. This quadrupolar field may be scanned to sequentially allow different mass-to-charge ions to pass, thus generating a mass spectrum.

The ion conduit may further be arranged at an elevated pressure by a buffer gas such that a substantial amount of collision occurs between charged particles and the buffer gas molecules. Here, the ion conduit is arranged to generate an electrical field applied along its axis, such that flight times across the ion conduit may be assigned to a mobility of the particles.

In yet a further embodiment, an apparatus is provided that includes a first mechanism that establishes a periodic motion of ions in accordance with ion properties (e.g., mass or size), and a second mechanism that establishes the period of the periodic motion of the ions according to detections inferred from a detection component.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a”, “an” and “the” include both singular and plural referents, unless the context clearly dictates otherwise. Thus, for example, “an apparatus” or “a device” includes one apparatus or device as well as plural apparatuses or devices.

In the following detailed description, for purposes of explanation and not limitation, representative embodiments disclosing specific details are set forth in order to provide a thorough understanding of the present teachings. Descriptions of known systems, devices, materials, methods of operation and methods of manufacture may be omitted so as to avoid obscuring the description of the example embodiments. Nonetheless, systems, devices, materials and methods that are within the purview of one of ordinary skill in the art may be used in accordance with the representative embodiments.

The present disclosure describes a technique of generating drifting ions that are separated in time and/or space on the basis of certain relative ion characteristics. Such relative ion characteristics include detected charge to mass ratio, detected collision cross section, and the like. As drifting ions drift through one or more light sheets introduced in a path of flight, light is emitted brought about by the interaction of the drifting ions with the light sheet(s).

In one scenario, time of detection may be determined or calculated relative to a predetermined start time of the drifting ion generation. The spatial separation between a reference location in the path of the drifting ions and the location of the light sheet may be predetermined. The mass or cross-section of ions may be determined using these parameters. The light may be scattered light from the light sheet which results from light within the light sheet scattering from an ion(s) whilst within the light sheet. The light may be emitted light from an ion(s) which results from fluorescence generated within the ion by absorption of light within the light sheet by an ion(s) whilst within the light sheet. The generation of drifting ions may be by use of a time-of-flight analyzer or methodology. The ions may be prepared with fluorescent markers, substances or components attached to them which are responsive to the light of the light sheet to fluoresce. The sheet of light may be arranged such that the direction of drift of the drifting ions is transverse to the plane of the sheet and most preferably substantially perpendicular. This methodology may be non-destructive of the detected ions and this enables multiple detection events to be performed in embodiments where multiple light sheets (and/or multiple passes through a given light sheet) are performed. The ability to perform multiple detections permits greater accuracy in final results by virtue of improving the detection statistics.

In accordance with a first exemplary embodiment, derivatization of macromolecular ions is performed prior to mass analysis using mass spectrometry and ion mobility platforms or combinations of both.

This derivatization of macromolecular ions is performed with fluorescent chemical reagents (also known as “fluorophores”). Fluorophores are highly responsive to light and the absorption/emission of light radiation over narrow wavelength bands occurs with high efficiency. Derivatization of large biomolecules or macromolecular assemblies is accomplished by attaching fluorophores to specific sites. In applications with proteins as the target species for mass and/or ion mobility analysis, the fluorophores are attached to the proteins.

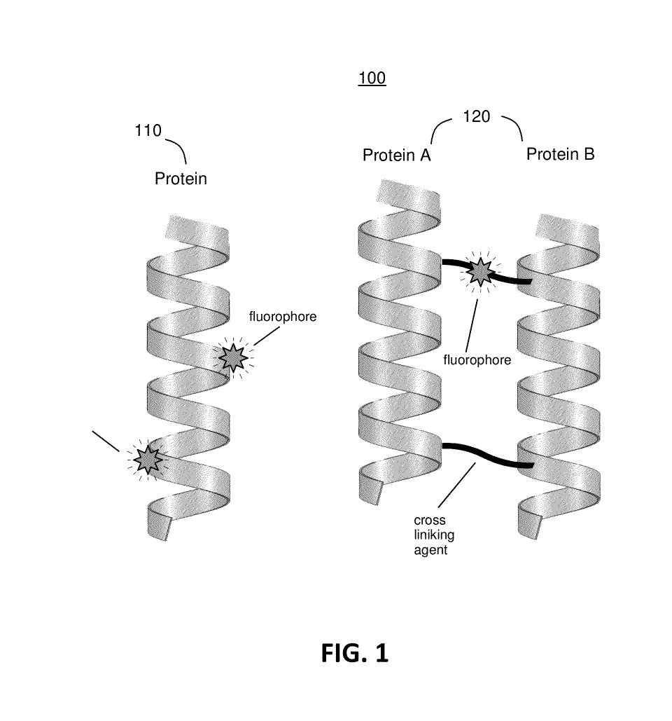

FIG. 1 shows various protein molecules 110, 120 in a form of a helix to which are attached fluorophores capable of emitting fluorescent light when excited by radiation at specific wavelengths. Ideally the decay of the excited state of the fluorophore is completed within a few ns.

In an exemplary embodiment of the present invention, the derivatized molecular species are ionized using “soft” ionization methods, such as for example Matrix-Assisted Laser Desorption Ionization (MALDI) or Electrospray Ionization (ESI) or variations thereof to prevent metastable or decay or dissociation of non-covalent complexes. Scaffolding agents may be used as well that are chemically modified to incorporate fluorophores. As explained, the protein complexes shown in FIG. 1 in a form of two helices connecting through a series of cross linking reagents are specifically modified to incorporate fluorophore molecules.

Fluorescent reagents may also be attached to specific amino acids of the protein complex. The process of tagging proteins or any other polymer chains including mixtures of different species is performed by mixing the target sample in solution with the solution containing specifically designed fluorophores. After waiting a predetermined period for the species to react in solution, the sample is ionized using any known soft ionization approach and subsequently analyzed using mass spectrometry and/or ion mobility platforms or combinations of both.

In one scenario, ion separation involves accelerating ions to a terminal velocity followed by injection into a drift region where separation is accomplished either by differences in mass-to-charge (m/z) ratio or by differences in cross section.

A drift region is a field-free region maintained at high vacuum conditions, preferably below 10⁻⁵ torr where the mean free path of the ions is at least comparable to the length of the field-free region and collisions with residual gas molecules should have no effect on the ion motion.

Under these conditions, ions are separated based on the principles of a time-of-flight (TOF) mass analyzer. Heavier ions are accelerated to lower velocities and exhibit longer flight times to reach the detection plane. The starting pulse for a TOF experiment is either produced by voltage pulses applied to electrodes for ejecting ions in the field-free region or laser pulses used for ionization on surfaces.

In a related approach, the drift tube (also commonly referred to as an “ion conduit”) is operated at elevated pressure and configured to produce a uniform accelerating electric field, for example within a pressure range of 100 torr to 10⁻³ tom Across this range of pressures, ions experience frequent collisions with buffer gas molecules and drift according to their relative ion mobility.

In contrast to a time-of-flight mass analyzer, where ions are separated according to their respective m/z ratios, here separation is based on differences in collision cross section and the number of charges on the ion, which partly determine the interaction potential with the buffer gas molecules. The interaction between ions and buffer gas molecules determines the drift velocity for a particular species, also known as the terminal velocity.

The terminal velocity differs for species with differences in the interaction potential thus producing a time-of-flight spectrum or mobility spectrum at the end of the drift region. Ions in ion mobility drift tubes ions are typically injected into the drift region by a Bradbury-Nielsen (BN) gate.

The present approach differs substantially from conventional detection methodologies, which as explained, rely primarily on a principle of directing ions against conversion dynode surfaces and determining flight time by producing electrons, which are then amplified to produce a fast analogue pulse from which inferences about the particles under examination nay be drawn.

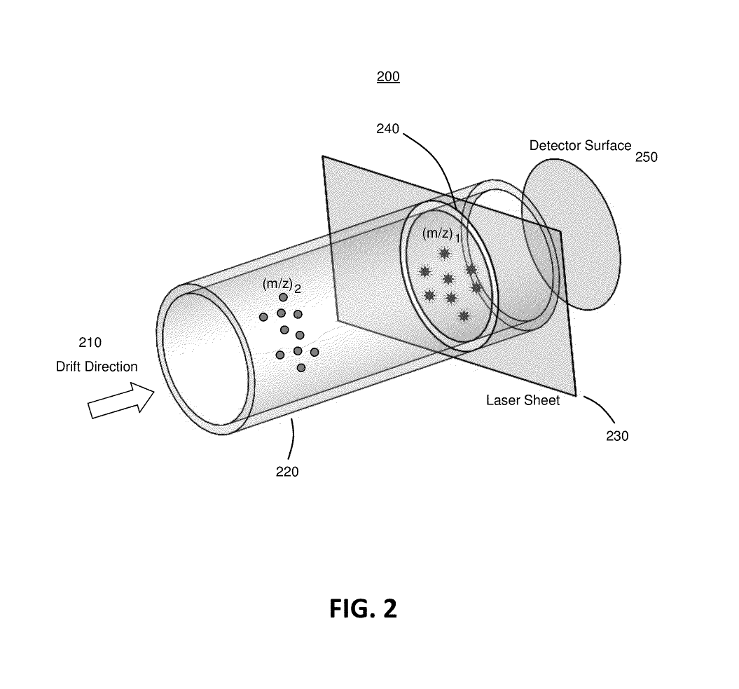

FIG. 2 shows an ion detection system which uses a laser sheet disposed along a plane perpendicular to the direction of an ion conduit to provide ion separations as a function of time, in accordance with an exemplary embodiment. Ions separated in time cross the plane sequentially to absorb and emit radiation collected on a photon detector.

In the presently proposed methodology, the same particles are modified to incorporate a fluorescent molecule and directed through an ion conduit—using cylindrical mirrors or other necessary light optical elements—and across a plane formed by a thin laser sheet. The thickness of the light sheet is of the order of a mm.

Ions separated along the ion conduit cross the light sheet sequentially absorbing and emitting photons. The photons are then captured by a photomultiplier. An analogue electrical pulse similar to the pulse produced by conventional discrete dynode or multi-channel plate detectors is initiated by a photon burst from each packet of ions crossing the light sheet.

A photomultiplier is employed to produce a time-of-flight spectrum. The density of the photon burst is proportional to the number of fluorophores attached to the ions. Consequently, detection efficiency is enhanced with molecular size or number of capable of accepting fluorescent tags. Conventional methods—which are based on secondary electron generation—experience detection efficiency that reduces exponentially in relation to mass size.

A Charge-Coupled Device (CCD) may be used to detect the photon burst necessary to obtain a spatially resolved image of the ion beam or the ion packets crossing a drift region. Time- and spatially resolved experiments are also possible using appropriate detection methods.

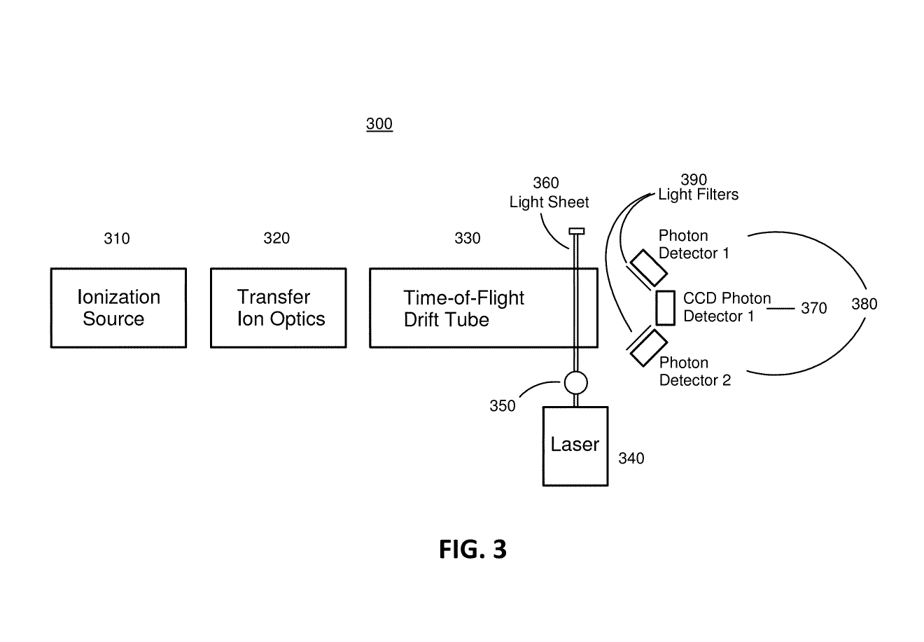

FIG. 3 is a high level block diagram of an ion detection system 300 in accordance with an exemplary embodiment.

The ion detection system 300 may be a mass spectrometer and comprised of an ionization source 310, transfer ion optics 320 and TOF mass analyzer 330.

Ionization source 310 is preferably selected from a list of “soft” ionization methods including MALDI and ESI. A MALDI source is preferably operated at high vacuum conditions and ions produced by the laser pulse are injected into an ion trap through a high vacuum lens for vibrational and translational thermalization. Mass analysis can be performed by axial injection of ions into TOF mass analyzer 330.

Other instrument configurations are envisaged where the MALDI target plate is incorporated into the ion trap or ions formed on the target surface are injected directly into the TOF system through a high-vacuum lens.

For an atmospheric pressure ionization source including ESI, transfer ion optics 320 may be comprised of a series of Radio-Frequency (RF) ion guides, including ion funnels, octapoles or other types of RF-multipole devices disposed over consecutive regions of progressively reduced pressure. For example an ion funnel may be disposed in the fore vacuum region of mass spectrometer 300 at pressure above 1 torr while RF-multipole systems are disposed as consecutive regions at a pressure ranging from 0.1 torr to 10⁻⁵ torr. In a preferred implementation, TOF analyzer is an orthogonal TOF (oTOF) mass analyzer.

Another preferred embodiment of an ion mobility spectrometer of the present invention also described with reference to FIG. 3 comprises an ionization source, including MALDI and ESI, followed by electrostatic or RF ion optics to direct ions toward a BN gate releasing pulses of ions into a drift tube. The drift path may be defined by an elongated drift tube consisting of a long electrode stack to form a uniform electrical field across. Variations to this standard ion mobility spectrometer may include two or more drift tubes arranged in series for tandem experiments or circular drift regions to produce a longer flight path within reasonable physical dimensions. Tandem ion mobility spectrometry experiments are particularly favored because the fluorescent method of detection is non-destructive and ions are detectable in every step of ion mobility analysis. It should be appreciated further that it is possible to detect certain species of particles using the proposed fluorescence detection scheme even when such species are neutralized in the drift area. Neutralization may result, for example, from energetic collisions with buffer gas molecules.

Referring to FIG. 3, a single laser sheet 360 and multiple photon detectors 370 are further deployed downstream. A sheet of light is generated by light source 340 and appropriate light optics 350 to define the end plane of a drift area defined by laser sheet 360.

This end-plane is substantially perpendicular to the principal ion drift direction. Light source 340 is optionally a lamp, a laser, a light emitting diode or an equivalent type light source. A laser might be of the continuous wave (CW) or pulsed (timed to coincide with ions of interest) type.

In one scenario, light source 340 is a CW diode laser emitting at violet or UV wavelengths or wavelength appropriately chosen to maximize fluorescent emission from target ions to improve sensitivity. Light from light source 340 may be manipulated by classical or diffractive optics and formed into a wide and thin sheet. The thickness of the light sheet is preferably kept to a minimum so that the TOF detection plane is well defined. As the species carrying the fluorescent groups pass through the light sheet they are expected to absorb light and consequently emit at the fluorescence wavelength. The emitted light is then detected by an appropriate light detection device 380 (e.g., photomultiplier, photodiodes, photodiode arrays, etc.) and recorded as a detection signal at the acquisition apparatus.

The time-of-flight from the start of the experiment to the detection of the fluorescence events can be translated to mass or cross-section, depending on the type of analyzer used. Appropriate optical apparatus may be employed to collect light from multiple directions and deliver it to the light sensing device, e.g. a set of mirrors or a waveguide.

The wavelength of the fluorescent light may differ from the wavelength of the incident light sheet (primary light beam). A detection mechanism for detecting the fluorescent photons may be equipped with a band pass filter 390 that blocks the primary light beam and allows the fluorescent light beam to pass through. A system of photomultipliers equipped with band pass filters is also shown in FIG. 3.

In another embodiment, two or more different fluorescent agents utilized in the sample preparation process, designed to emit at different wavelengths. In such case the detector may be equipped with multiple light sensing devices each equipped with an appropriate narrow band pass filter 390 to differentiate time arrivals of the respective sample constituents.

Alternatively, a monochromator or similar light separating device is employed. Using a monochromator, for example, similar or identical molecules can be simultaneously but independently identified and relatively quantified in a single experiment. Isophorms and isomers can also be practically treated with different fluorescent dyes and differentiated even when arrival times are very similar. In another approach, a standard control sample is treated with a different fluorescent agent to avoid interference with the unknown sample in the detection phase.

In the event where it may be desirable or for other reasons not possible to utilize a band pass filter, accommodations must be made to ensure the primary light beam is prevented from reaching the light detection area. A light screen, a light absorbing medium, or other optical device or technique may be used for this purpose.

The time interval between light absorption and fluorescence light emission is an important parameter. In general, short half-life fluorescent transitions (compared to the time of flight through the light sheet) are preferable. A single species passing through the light sheet may have time to absorb and emit several photons. This will result to broadening of the detection signal for a single species. Additionally, when a narrow packet of identical species passes through the light sheet, different individual species of the packet may emit at different times; this will also result to broadening of the detection signal for a single sample species. It is therefore preferable that the thickness of the light sheet is kept low, as, together with the fluorescence time constant, are the two most important determinants of detection peak broadening.

In contrast to the above, in the case when the initial sample containing the analyte is simple, e.g. the sample is purified and/or there is a single species or multiple species with adequate mass differences are to be measured, a broad arrival time peak can be further analyzed and its leading and trailing edges of the acquired signal (which correspond to the measured sample entering and exiting the detection region respectively), can be used to improve the accuracy of the measurement.

In another implementation, a single CW laser light source is treated with diffractive or non-linear optics to produce a multiple line pattern, defining a number of parallel light sheets—measurement planes.

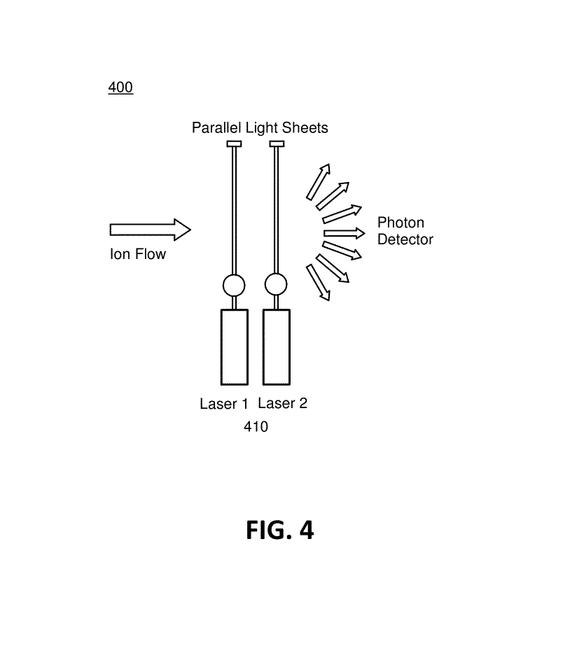

FIG. 4 shows a fluorescence time-of-flight (TOF) detection system with two lasers operated at different wavelengths, in accordance with a further exemplary embodiment.

Here, multiple lasers 410 are used to generate multiple light sheets. Beam splitters and conventional optics or other light sources may also be employed instead.

Every time a species passes through each one of the detection places it will emit one or more fluorescence photon. As a single species passes though the multiplicity of measurement planes it will emit a series of signals with a time difference related to the species velocity. The multiple signals may be mathematically deconvoluted using appropriate algorithms, so that overall sensitivity is enhanced. Additionally, the peak shapes resulting from each measurement plane may be utilized to improve statistical significance and improve accuracy.

Diffractive optics may be employed to generate a line pattern with adequate width to cover the area of the detection plane.

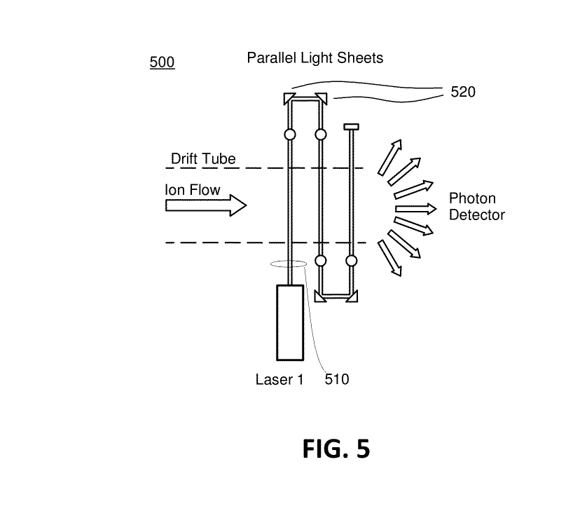

FIG. 5 shows a fluorescence TOF detection system with multiple detection planes in a yet a further exemplary embodiment.

Here, a plurality of conventional lenses 510 and mirrors 520 (or beam splitters could be used), at least one of them being cylindrical, are employed.

In another embodiment, light detection is performed by a light sensing array detector, e.g., CCD or CMOS device 370, with appropriate shutter speed or other position and time sensitive light detection devices. The light sensing array detector may be equipped by appropriate optics that can focus the image of the whole detection plane onto the array light detector. The output of such a device would include the position where a species is found in the detection plane as well as the arrival time.

This information can be used to determine the position of the detected species in the ion source, assuming that ion optics with stigmatic focusing properties are employed. In another embodiment of the aforementioned device, a dual measurement plane is generated by means of diffractive or conventional optics.

A light sensing array detector may be employed which is focused to monitor the second plane.

The first plane is surveyed by a light sensing device with fast response, e.g. a photodiode or a photon multiplier. Signals from species that pass through the first detection plane may be used to trigger the shutter of the light sensing array so as to capture the images of fluorescing ions as they pass through the second detection plane.

In yet a further embodiment, a set of multiple detection planes as described previously coincides with a non-zero electric field area to affect flight time of charged species. Such device could measure the charge state of detected species by determining the effect of the electric field in time-of-flight between consecutive detection planes.

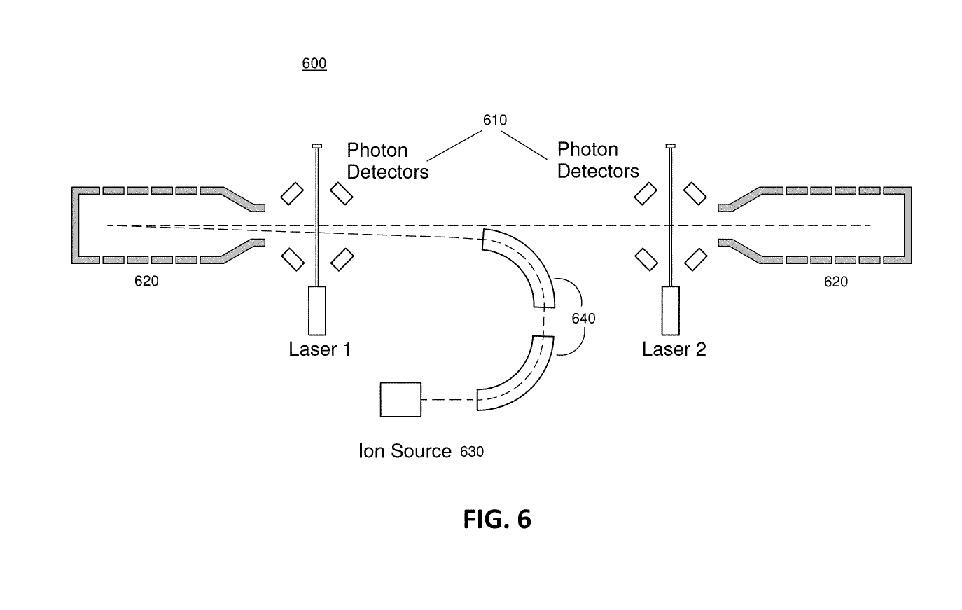

FIG. 6 shows a coaxial multi-pass TOF mass analyzer 600 employing two fluorescence detection systems for Fourier transform mass spectrometry experiments in another exemplary embodiment.

Here, ions are forced to undergo periodic oscillations through two or more light detection planes 610. The periodic ion motion is mass-to-charge ratio or collision cross section dependent. The resulting signal collected by the detectors is using Fourier transform algorithms and, given an adequate number of passes, will reveal with high accuracy the period of the ion motion. The period can be designated to the mass-to-charge ratio or the collision cross section of the molecules with high accuracy. In one mode of operation, ions are trapped between two coaxial reflectrons 620.

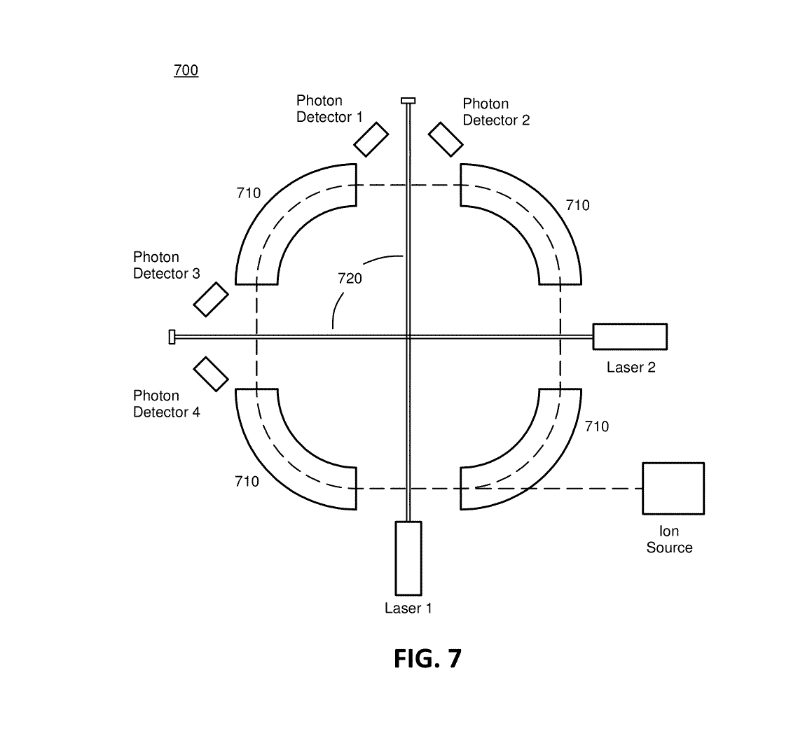

FIG. 7 shows a multi-turn TOF mass analyzer employing a plurality of fluorescence detection systems for Fourier transform mass spectrometry experiments in yet another exemplary embodiment.

Here, ions are trapped in a multi-turn TOF 700 comprised of multiple electric sectors with at least two detection planes 710 formed in the field-free region and perpendicular to the ion path.

Coaxial TOF system 600, also referred to as multi-pass TOF mass analyzer, is equipped with an ion source 630, preferably an RF storage trap for trapping and manipulating ions and ejecting those ions into the TOF analyzer through a system of electrostatic sectors 640.

Other types of multi-pass TOF systems known to those skilled in the art of mass spectrometry are envisaged and may be readily to perform high-mass ion analysis based on the fluorescent detection methods disclosed in the present invention. The detection method can be performed using a typical time-of-flight experiment or based on oscillatory ion motion and Fourier transform methods. In a multi-turn TOF system multiple detection planes may be employed (2 or 4) in the field-free region established between sectors to accelerate the measurement hence improve mass resolving power.

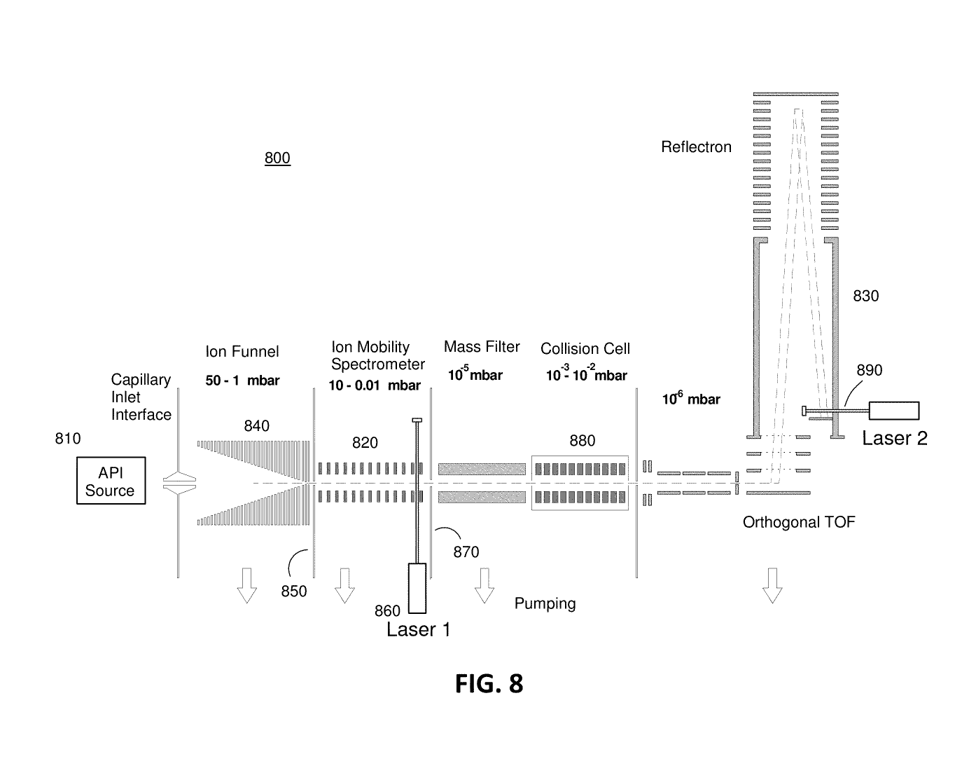

FIG. 8 shows a hybrid mass spectrometer apparatus 800 incorporating a low pressure ion mobility spectrometer 820 and TOF mass analyzer 830 in series, both equipped with fluorescence detection in accordance with yet another exemplary embodiment.

Here, hybrid mass spectrometer apparatus 800 is equipped with an atmospheric pressure ionization source 810 to generate ions which are subsequently sampled by a temperature controlled capillary inlet and transferred into the fore vacuum region. An ion funnel 840 is disposed in the fore vacuum and operated at pressures from 1 torr to 50 torr. Ions are focused through a narrow aperture in a subsequent vacuum region at lower pressure enclosing an ion mobility spectrometer 820 equipped with a BN gate 850 to affect periodic injections of ion pulses into the drift region, a fluorescent light detector system 860 for measuring the flight time from the BN gate to the light sheet and preferably a second BN gate 870 to selectively transit ions into the subsequent vacuum region equipped with a quadrupole mass filter and a collision cell.

Another fluorescent light detector could be employed after the quadrupole mass filter in order to acquire mass spectra at this part of the device. Finally, mass analysis of high mass precursor ions and/or fragment ions is performed using an orthogonal acceleration TOF mass analyzer 830 and configured to accept another light sheet to form a second fluorescent detection scheme 890 for the determination of mass-to-charge ratio.

It should be appreciated that it is possible to combine the proposed detection scheme disclosed herein with conventional methods of detection for high mass ions. For example, it is possible to use post-acceleration techniques for high ion impact energy or to use cryogenic conversion dynode surfaces.

It should further be appreciated that the ion conduit may be arranged to provide quadrupolar field with characteristics such that ions of certain mass-to-charge ratio are dispersed and removed from the ion conduit while selected ions pass successfully through the conduit and arrive at the light sheet, generating photons and registering a signal. The quadrupolar field may be scanned to sequentially allow different mass-to-charge ions to pass, thus generating a mass spectrum.

The thickness of the light sheet at the relevant location may be in the range of about 0.01 mm to 5 mm, or more preferably about 0.02 mm to about 2 mm, or yet more preferably about 0.05 mm to about 0.5 mm, or even more preferably about 0.05 mm to 0.2 mm (e.g. about 0.1 mm). The light sheet may be formed by directing a laser beam into an optic comprising a cylindrical lens, in a direction substantially perpendicular to the cylindrical axis of the lens. Alternatively, the optic may comprise a plano-convex converging lens arranged coaxially with a plano-concave diverging cylindrical lens located within the focal length of the plano-convex lens. A light sheet is formed at the planar output side of the diverging lens, from the laser beam input to the convex input side of the converging lens. Alternatively, the optic may comprise a first plano-convex converging lens arranged coaxially with a second plano-convex diverging cylindrical lens located beyond the focal length of the first plano-convex lens. A light sheet is formed at the planar output side of the second converging lens, from the laser beam input to the convex input side of the first converging lens. Other optical arrangements such as would be readily apparent to the skilled person may be employed in the optics such as one or more cylindrical mirrors arranged perpendicular to the laser beam or non-linear diffractive optics designed to generate line patterns.

Proposed herein are, inter alia, techniques of identifying particle properties in a mass (or ion mobility) spectrometer that includes an ion conduit and a detection area at or near an end of the ion conduit that is illuminated by light radiation such that fluorescent agents attached to particles emit photons as they pass through the detection area. The spectrometer is of the type which also further includes detectors that measure time and position.

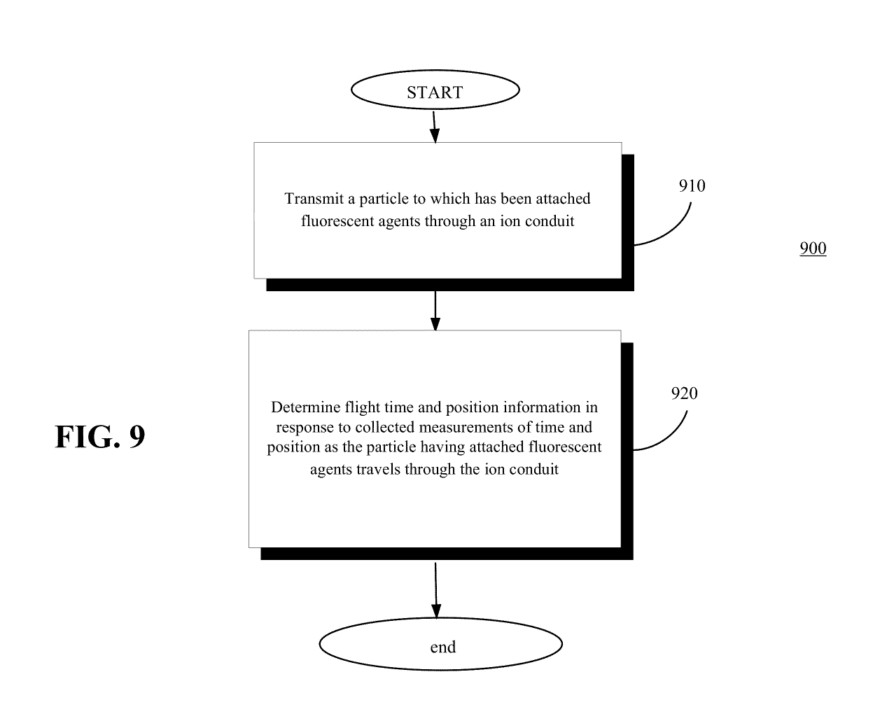

FIG. 9 is an operational flow diagram for attaching fluorescent agents to particles in order to emit photons as the particles pass through a detection area to help with identification of same in accordance with an exemplary embodiment.

Referring to FIG. 9, as a first step shown, the spectrometer operates to transmit particles through the ion conduit to which have been attached fluorescent agents 910. As the particles drift through the ion conduit, information is collected and recorded. Flight time and position information is determined specifically in response to collected measurements of time and position recorded during the drift of particles with the attached fluorescent agents through the ion conduit 920. This “flight time and position” determination serve as particle properties the identification of which assists in the identification of the particles themselves as well as for other purposes.

It should be appreciated that by particles, as this term is used herein, this is meant to include molecules, including protein molecules, DNA molecules, polymer molecules, other macromolecules, a cluster of molecules, a virus, a piece of dust, or any species of particles normally known and understood as being detectable by mass and ion spectrometry type equipment.

Also, while the term “ion conduit” is used, it is to be understood that the particles being transmitted therethrough need not be “ionized” particles as such, and in this regard the conduit serves simply as a drift tube, which term is also used herein.

In view of this disclosure it is noted that the methods and apparatuses can be implemented in keeping with the present teachings. Further, the various components, materials, structures and parameters are included by way of illustration and example only and not in any limiting sense. In view of this disclosure, the present teachings can be implemented in other applications and components, materials, structures and equipment to needed implement these applications can be determined, while remaining within the scope of the appended claims.

Those of skill in the art would understand that information and signals may be represented using any of a variety of different technologies and techniques. For example, data, instructions, commands, information, signals, bits, symbols, and chips that may be referenced throughout the above description may be represented by DC voltages, currents, RF voltage waveforms and corresponding electric fields, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of identifying particle properties in an apparatus including an ion conduit and a detection area at or near an end of the ion conduit that is illuminated by light radiation such that fluorescent agents attached to particles emit photons as they pass through the detection area, and further including detectors that measure time and position, comprising:
transmitting a particle to which have been attached fluorescent agents through the ion conduit; and
determining flight time and position information in response to collected measurements of time and position as the particle having attached fluorescent agents travels through the ion conduit.

2. An apparatus comprising:
means for generating a source of fluorescent particles;
means to separate the particles, as a function of time and/or space, which separation results from uniqueness of particle properties;
means to illuminate a detection area with light radiation; and
means to detect the time and/or position of photons emitted by the particles as they cross the detection area.

3. The apparatus of claim 2, where the photons are emitted in any direction from particles as the particles cross the detection area, the apparatus further comprising optical devices to direct the photons to a photon detector.

4. The apparatus of claim 2, further comprising a plurality of detection areas positioned within an ion conduit, each generating detection signals as particles pass through its respective detection area.

5. The apparatus of claim 2, wherein the detection area is generated by an independent light collection and detection apparatus.

6. The apparatus of claim 2, wherein the detection area is illuminated by a continuous wave light radiation emitted by at least one of a laser and light emitting diode light source.

7. The apparatus of claim 2, wherein the detection area is illuminated by a laser beam conditioned to form a thin light sheet defining the detection area.

8. The apparatus of claim 2, wherein the means to detect the time and/or position of photons emitted by particles includes a 2-dimensional photon detecting device that records the position of detection of the particles crossing the detection area.

9. The apparatus of claim 8, wherein the 2-dimensional photon detecting device records at a frame rate that is higher than 100 per second.

10. The apparatus of claim 2, whereas the particles are charged particles.

11. The apparatus of claim 2, wherein the charged particles are particle packets generated by at least one of a pulsed ionization source and an ion gate.

12. The apparatus of claim 2, wherein the particles are separated in space in the ion conduit as a function of particle velocity.

13. The apparatus of claim 12, wherein particles entering the drift tube possess substantially the same kinetic energy.

14. The apparatus of claim 13, wherein the ion conduit is at high vacuum such that flight of particles through the drift tube is substantially collision free.

15. The apparatus of claim 14, wherein the drift tube is free of electrical fields.

16. The apparatus of claim 15, further comprising means for assigning flight times across the ion conduit on the basis of the mass of the particles.

17. The apparatus of claim 15, wherein the ion conduit is found at an elevated pressure of a buffer gas such that a substantial amount of collision occurs between charged particles and molecules of the buffer gas.

18. The apparatus of claim 17, wherein the ion conduit has an electrical field applied along its axis.

19. The apparatus of claim 18, wherein flight times across the ion conduit are assigned to the mobility of the particles.

20. An apparatus comprising:
means for generating fluorescent particles having a charge;
means for setting the fluorescent particles in periodic motion on the basis of particle properties;
means for illuminating one or more detection areas with light radiation within the periodic path of the fluorescent particles;
means for detecting the time of photons emitted by the particles as they cross the one or more detection areas; and
means for determining the period of motion of the fluorescent particles by processing signals detected at the one or more detection areas.
